(19) United States
(12) Patent Application Publication
(10) Pub. No.: US 2012/0141764 A1
(43) Pub. Date: Jun. 7, 2012

(54) MULTI GLASS FIBER BONDED HIGH STRENGTH PLASTIC BACK BEAM

(75) Inventors: Seung Mok Lee, Gunpo-si (KR); Nae Ung Jang, Anyang-Si (KR); Dong Eun Cha, Seongnam-si (KR); Hun Soo Kim, Bucheon-si (KR); Hoo Taek Cho, Yongin-si (KR); Hee June Kim, Daejeon (KR); Gi Hune Jung, Daejeon (KR)

(73) Assignees: Hyundai Motor Company, Seoul (KR); LG Hausys, Ltd., Seoul (KR); Kia Motors Corp., Seoul (KR)

(21) Appl. No.: 13/303,816

(22) Filed: Nov. 23, 2011

(30) Foreign Application Priority Data
Dec. 6, 2010 (KR) 10-2010-0123374

(51) Int. Cl. B32B 27/04

(52) U.S. Cl. 428/297.4

(57) ABSTRACT

A multi-glass fiber bonded high-strength plastic back beam for a vehicle bumper, which may be made of glass fiber and thermoplastic resin, may include a first fiber resin layer in which long fiber or short fiber may be bonded with thermoplastic resin, and a second fiber resin layer in which continuous fiber may be bonded with thermoplastic resin, wherein, when the first fiber resin layer may be independently attached onto the second fiber resin layer by heating, the long fiber or short fiber of the first fiber resin layer may be configured not to permeate between the continuous fibers of the second fiber resin layer.

### CROSS-REFERENCE TO RELATED APPLICATION

The present application claims priority to Korean Patent Application No. 10-2010-0123374, filed on Dec. 6, 2010, the entire contents of which is incorporated herein for all purposes by this reference.

### BACKGROUND OF THE INVENTION

1. Field of the Invention

The present invention relates to a multi-glass fiber-bonded high-strength back beam, and, more particularly, to a multi-glass fiber-bonded high-strength back beam, the collision performance of which is improved by differentiating the arrangement of glass fiber.

2. Description of Related Art

Generally, a vehicle bumper is provided therein with a back beam in order to improve the durability thereof, and this back beam is fixed on a vehicle body by a stay.

The back beam is largely made of a steel material or a plastic material such as glass mat thermoplastic (GMT).

The back beam made of a steel material is advantageous in that it has a high degree of design freedom because it can be formed in various shapes, but is disadvantageous in that it has a bad influence on the weight savings of a vehicle body and the improvement of travel distance per unit amount of fuel and in that it is difficult to meet the rules of the low-speed collision test provided by the IIHS (Insurance Institute for Highway Safety) in the U.S.A.

In contrast, the plastic back beam made of GMT is advantageous in that it greatly contributes to the weight savings of the vehicle body because it is a composite material of glass fiber and resin, which has similar strength to cold-rolled steel, and in that it can comply with the rules of the low-speed collision test provided by the IIHS (Insurance Institute for Highway Safety) of the U.S.A. because it has excellent collision energy absorptivity, but is disadvantageous in that its design freedom is low because it is difficult to make this plastic back beam round.

GMT, which is a typical plastic composite material, is a plate-like composite material including a polypropylene resin, as a general-purpose resin, and a glass fiber mat. GMT has strong bonding force to resin because the glass fiber mat is directly impregnated with molten polypropylene extruded by a T-die, exhibits higher strength than conventional plastic materials because the strength of glass fiber itself added to the glass fiber mat, and has various characteristics such as light weight, which is an inherent property of plastic, high productivity attributable to thermoplastic resin, recycling properties, etc.

FIG. 1 shows two types of typical GMTs manufactured by a double belt press. FIG. 1A shows GMAT manufactured by heating a non-directional polypropylene resin 10 and impregnating a random glass fiber mat 11 with the non-directional polypropylene resin 10, and FIG. 1B shows GMAT manufactured by heating a non-directional polypropylene resin 10 and impregnating a uni-directional glass fiber mat 13 with the non-directional polypropylene resin 10. These two types of typical GMTs are properly used according to the use thereof.

However, the GMT, which is most generally used as a plastic back beam for a vehicle bumper, is problematic in that, when it is manufactured by a laminating process, imperfect packing occurs between a glass fiber and a resin, thus decreasing the bonding force therebetween, and in that, during a forming process, a flow phenomenon occurs, so that the directionality of glass fiber becomes unstable, thereby causing the scattering phenomenon of glass fiber arrangement. Particularly, there is a problem in that the scattering phenomenon of glass fiber arrangement inhibits collision energy from being uniformly absorbed, thus deteriorating the quality of a product.

WLFT (Weaving Long Fiber Thermoplastics), which have been lately developed as a composite material of a back beam for a vehicle bumper, is manufactured by attaching CFT (Continuous Fiber reinforced Thermoplastics) to LFT (Long Fiber Thermoplastics) by pressing. However, this WLFT is also problematic in that, during high-temperature pressing, long fiber or short fiber permeates between continuous fibers, thus deteriorating high-strength properties which are physical properties exhibited by continuous fiber.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a multi-glass fiber-bonded high-strength back beam, which can maintain high-strength properties and simultaneously accomplish uniform collision performance distribution by independently attaching a resin layer of continuous fiber and a resin layer of long fiber (short fiber) to each other.

In an aspect of the present invention, a multi-glass fiber bonded high-strength plastic back beam for a vehicle bumper, which is made of glass fiber and thermoplastic resin, may include a first fiber resin layer in which long fiber or short fiber is bonded with thermoplastic resin, and a second fiber resin layer in which continuous fiber is bonded with thermoplastic resin, wherein, when the first fiber resin layer is independently attached onto the second fiber resin layer by heating, the long fiber or short fiber of the first fiber resin layer is configured not to permeate between the continuous fibers of the second fiber resin layer.

The first fiber resin layer is disposed outward to form a collision surface, and the second fiber resin layer is attached onto an inner side of the first fiber resin layer.

The multi-glass fiber bonded high-strength plastic back beam may further include a resin film layer at an interface between the first fiber resin layer and the second fiber resin layer to attach the first and second fiber resin layers such that interlayer peeling does not occur and to prevent the long fiber or the short fiber from permeating between the continuous fibers.

A length of a section of the second fiber resin layer is 50% or more of a length of a section of the first fiber resin layer corresponding to a total section length of the back beam.

Both ends of the second fiber resin layer are directly connected to a stay for fixing a vehicle body, and the first fiber resin layer covers the second fiber resin layer and the both ends of the second fiber resin layer.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows the structures of a general GMT.

FIG. 2 is a perspective view showing a high-strength plastic back beam according to an exemplary embodiment of the present invention.

FIG. 3 is a sectional perspective view showing a high-strength plastic back beam according to an exemplary embodiment of the present invention.

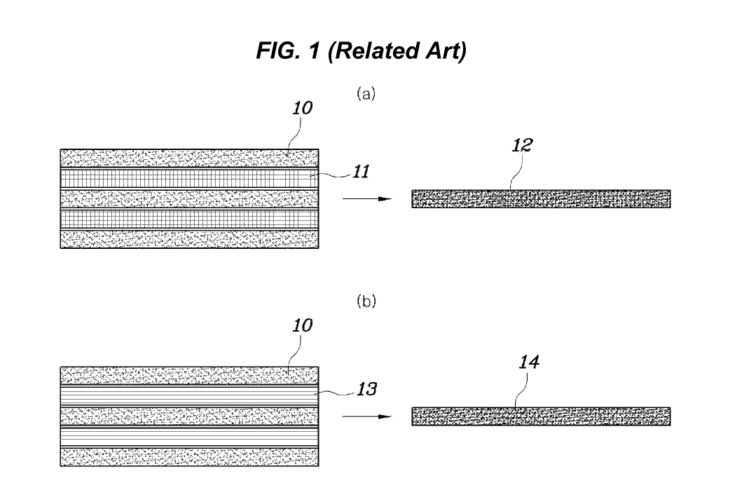

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, preferred embodiments of the present invention will be described in detail with reference to the attached drawings.

However, embodiments of the present invention can be modified in various forms, and the scope of the present invention is not limited to the following embodiments. Embodiments of the present invention are provided in order to allow those skilled in the art to clearly understand the present invention. Therefore, it should be kept in mind that the shape, size and the like of components shown in the drawings may be exaggerated for the purpose of providing a clear explanation.

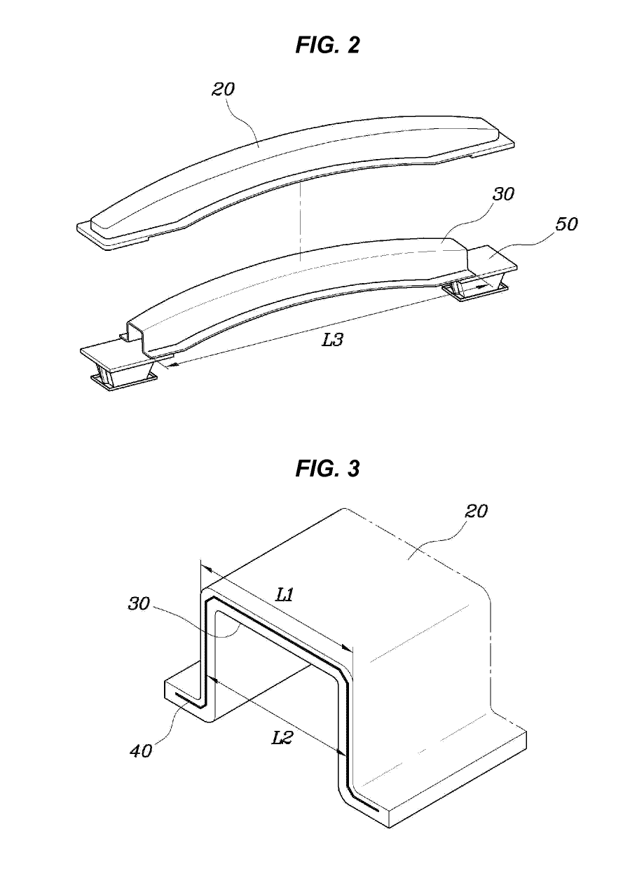

FIG. 2 is a perspective view showing a high-strength plastic back beam according to an exemplary embodiment of the present invention.

The high-strength plastic back beam of the present invention, which is made of a glass fiber and a thermoplastic resin, includes: a first fiber resin layer 20 in which a long fiber or a short fiber is bonded with a thermoplastic resin, and a second fiber resin layer 30 in which a continuous fiber is bonded with a thermoplastic resin.

It is preferred that all of the long fiber, short fiber and continuous fiber be made of glass fiber, but may also be made of other fiber materials as long as they can be used for the same purpose as glass fiber. It is preferred that a polypropylene (PP) resin, which is a general-purpose resin having been conventionally used for composite materials such as GMT and the like, be used as the thermoplastic resin, but other thermoplastic resins may be used as the thermoplastic resin as long as they can be used for the same purpose as the polypropylene (PP) resin.

The first fiber resin layer 20 is formed by attaching a long fiber or a short fiber to a thermoplastic resin using an impregnation method. Although the standard that can absolutely distinguish the length of a short fiber from the length of a long fiber is not defined, a short fiber (staple fiber) means a pellet type fiber having a short length of about 2.5˜3.8 cm, and a long fiber (filament) means a fiber which is thinner and longer than the short fiber. Since a glass fiber is a synthetic mineral fiber formed by extruding molten glass in the shape of a fiber, a long fiber or a short fiber can be freely prepared using the glass fiber according to the purpose thereof. A short glass fiber includes glass cotton and glass wool, and a long glass fiber is chiefly fabricated by extruding molten glass in a platinum pot through small holes formed in the bottom of the platinum pot.

Since the long fiber and short fiber are resistant to high temperature because of the characteristics of the glass fiber, when they are heated to high temperature in a state of being bonded with a thermoplastic resin, they tend to be moved by the flow phenomenon of the thermoplastic resin and thus to permeate between the continuous fibers of the second fiber resin layer 30. As such, when the long fiber and short fiber permeate between the continuous fibers of the second fiber resin layer 30 because of their movement, as described above, the arrangement of each of the fiber resin layers cannot be independently maintained, thus deteriorating the high strength characteristics. In an exemplary embodiment of the present invention, in order to solve the above problem, the first fiber resin layer 20 including a long fiber or a short fiber is independently distinguished from the second fiber resin layer 30 including a continuous layer.

Meanwhile, the second fiber resin layer 30 is formed by attaching a continuous fiber to a thermoplastic resin using an impregnation method. As described above, since a glass fiber is a synthetic mineral fiber formed by extruding molten glass in the shape of a fiber, it corresponds to most stable continuous fiber. In an exemplary embodiment of the present invention, considering the direction of a maximum load applied to a back beam, the continuous fibers are arranged such that the back beam can exhibit maximum strength, and are then bonded with a polypropylene resin to prevent cracks from occurring and propagating, thereby accomplishing the high-strength characteristics required of the back beam.

In this case, in order for the back beam to exhibit high-strength characteristics due to continuous fibers, the arrangement of continuous fibers must be stably maintained. For this purpose, it is important that, when the first fiber resin layer 20 is attached to the second fiber resin layer 30 by heating, the second fiber resin layer 30 made of continuous fiber is always independently disposed by preventing the long fiber or short fiber from permeating between the continuous fibers through the interface therebetween.

As such, methods of independently disposing the second fiber resin layer 30 made of continuous fiber largely include a method of controlling an attaching process condition and a method of attaching an additional resin film layer 40 between the first fiber resin layer 20 and the second fiber resin layer 30.

First, in the method of controlling an attaching process condition, the attaching process condition is to prevent long fiber or short fiber from permeating between continuous fibers by heating and attaching the first fiber resin layer 20 to the second fiber resin layer 30 at a temperature at which the flow phenomenon of the long fiber or short fiber does not occur, in consideration of physical properties of a thermoplastic resin. This method is advantageous in that the independence of continuous fiber can be maintained without using additional means, but is problematic in that the application thereof is limited depending on the physical properties of resin or the characteristics of glass fiber.

Next, as shown in FIG. 3, in the method of attaching an additional resin film layer 40 between the first fiber resin layer 20 and the second fiber resin layer 30, the resin film layer 40 is additionally attached between the first fiber resin layer 20 and the second fiber resin layer 30 to prevent interlayer separation. In this method, the independence of the arrangement of continuous fibers is completely assured, and simultaneously interlayer adhesion is further improved by using a resin film having high adhesivity, thus preventing the occurrence of the interlayer peeling phenomenon at the time of collision. As the resin film layer 40, any resin film layer may be used as long as it exhibits physical properties, such as adhesivity and the like, required of the back beam of the present invention.

Further, the back beam of the present invention may be configured such that the first fiber resin layer 20 is disposed outward to form a collision surface and the second fiber resin layer 30 is attached to the inner side of the first fiber resin layer 20. More specifically, as shown in FIG. 3, the first fiber resin layer 20, which has excellent collision energy absorption performance because long fibers or short fibers having relatively short length are uniformly distributed therein, is mounted outward to form a direct collision surface, and the second fiber resin layer 30, which exhibits high strength because continuous fibers are uniformly arranged therein in a predetermined direction, is mounted on the inner side of the first fiber resin layer 20 to prevent the back beam from being deformed by eternal impact.

Further, as shown in FIG. 3, the back beam may be configured such that the section length (L2) of the second fiber resin layer 30 is 50% or more of the section length (L1) of the first fiber resin layer 20 corresponding to the total section length of the back beam. The reason for this is because, when the section length (L2) of the second fiber resin layer 30 having high strength is less than 50%, the back beam is deformed at the time of a collision, thus deteriorating the structural stability of the back beam.

Furthermore, as shown in FIG. 2, the back beam may be configured such that both ends (L3) of the second fiber resin layer 30 are directly connected to a stay 50 for fixing a vehicle body, and the first fiber resin layer 20 covers the both ends of the second fiber resin layer 30 attached to the inner side thereof. The reason for this is because a high-strength back beam can be advantageously realized when the two ends of the second fiber resin layer 30 are connected to the stay 50 and because the collision energy absorption performance of the back beam can be excellent when it receives an external impact in all directions when the first fiber resin layer 20 containing long fiber or short fiber covers the two ends of the second fiber resin layer 30.

As described above, according to the multi-glass fiber-bonded high-strength back beam of the present invention, since continuous fiber is independently disposed, high strength can be maintained.

Further, since long fiber or short fiber cannot permeate between continuous fibers, at the time of forming, the arrangement of continuous fibers is independently maintained, thus improving the uniform absorptivity of collision energy.

Furthermore, since long fiber or short fiber is attached to continuous fiber, the freedom of shape of the back beam can be maintained to an extent similar to that of conventional back beams.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A multi-glass fiber bonded high-strength plastic back beam for a vehicle bumper, which is made of glass fiber and thermoplastic resin, comprising:
a first fiber resin layer in which long fiber or short fiber is bonded with thermoplastic resin; and
a second fiber resin layer in which continuous fiber is bonded with thermoplastic resin,
wherein, when the first fiber resin layer is independently attached onto the second fiber resin layer by heating, the long fiber or short fiber of the first fiber resin layer is configured not to permeate between the continuous fibers of the second fiber resin layer.

2. The multi-glass fiber bonded high-strength plastic back beam according to claim 1, wherein the first fiber resin layer is disposed outward to form a collision surface, and the second fiber resin layer is attached onto an inner side of the first fiber resin layer.

3. The multi-glass fiber bonded high-strength plastic back beam according to claim 1, further comprising a resin film layer at an interface between the first fiber resin layer and the second fiber resin layer to attach the first and second fiber resin layers such that interlayer peeling does not occur and to prevent the long fiber or the short fiber from permeating between the continuous fibers.

4. The multi-glass fiber bonded high-strength plastic back beam according to claim 3, wherein the first fiber resin layer is disposed outward to form a collision surface, and the second fiber resin layer is attached to an inner side of the first fiber resin layer.

5. The multi-glass fiber bonded high-strength plastic back beam according to claim 4, wherein a length of a section of the second fiber resin layer is 50% or more of a length of a section of the first fiber resin layer corresponding to a total section length of the back beam.

6. The multi-glass fiber bonded high-strength plastic back beam according to claim 4, wherein both ends of the second fiber resin layer are directly connected to a stay for fixing a vehicle body, and the first fiber resin layer covers the second fiber resin layer and the both ends of the second fiber resin layer.
